(19) United States
(12) Patent Application Publication
(10) Pub. No.: US 2012/0097607 A1
(43) Pub. Date: Apr. 26, 2012

(54) SEWAGE TREATMENT PLANT

(76) Inventor: Josef Merai, Sulzbach (DE)

(21) Appl. No.: 13/138,170

(22) PCT Filed: Jan. 15, 2010
(86) PCT No.: PCT/DE2010/000065

§ 371 Date: Jan. 3, 2012

(30) Foreign Application Priority Data
Jan. 15, 2009 (DE) 10 2009 004 619.4

(51) Int. Cl. C02F 9/14; F26B 21/00; C02F 11/00; B02C 13/00

(52) U.S. Cl. 210/609; 210/151; 210/114; 210/298; 241/194; 34/524; 425/6

(57) ABSTRACT

Waste water conditioning has nearly 150 years of history. During this time, a method has developed that is considered to be state of the art. While this method meets the requirements at hand, it is complicated and expensive. The novel method breaks down the rigidly entrenched method and simplifies it. In a plurality of stages, the only energy that is used is gravity, which is readily available and free of cost. Thus, an “alternative sewage treatment plant” has been developed, which has a simpler method and is less expensive in terms of investment costs and operating costs, at the same capacity, and requires only a fraction of the previous required surface area. The most important characteristic of the invention is that the novel method separates solids from waste water immediately after entering the sewage treatment plant. Mechanically purified water is much faster, easier and less expensive to purify. The paths pursued for conditioning of the sludge are also new. The sludge is regarded as an energy source or recyclable material, which should be utilized accordingly. According to the invention, the prerequisite for utilizing the sludge is also created by economically drying it to 95 to 98% dry substance.

### PRIOR ART

Given increased population densities and the associated pollution of the environment, it is necessary to clarify municipal, industrial and agricultural waste water (liquid manure). This is done by sewage treatment plants, which have been being built for approximately 150 years now, and in many instances have been adapted to new requirements, in terms of the technology thereof. Today, technology exists that allows waste water to be purified so that it can be discharged into public water systems without posing a hazard.

The degree of pollution is characterized by various parameters. CSB denotes the chemical oxygen consumption, which is to say the quantity of oxygen that is required for degrading the chemical loads, BSB5 denotes the same for biological pollution, the content of phosphates and nitrates in mg/l, and the residual substances, likewise in mg/l, that can settle. These limits vary from one country to another, but are relatively close to each other everywhere.

In order to achieve the statutory limits, comprehensive sewage treatment plants are being built, which degrade the aforementioned pollutants in various process stages and use various technologies. A classic sewage treatment plant thus comprises:

a coarse screen, where the coarsest pollutants such as rags, condoms, fruit skins and the like can be separated. These pollutants are pressed out and delivered to a disposal site or incinerated; then, a fine screen follows, where additional, but still relatively large parts are segregated.

a sand trap: Here, the flow of the water is slowed down, whereby the heaviest inorganic matter, primarily sand, settles. This sand is suctioned off by a continuously running suction mechanism and pumped into a screen container, from where the sand is delivered to the disposal site.

The sand is mixed with fecal matter, for which reason sand washing systems are being built of late where the fecal matter is rinsed out. This then allows the sand to be recycled in the building industry. The disadvantage: the sludge produced in this way is several times more expensive than pit sand or drift sand that is available in unlimited quantities.

a mechanical sedimentation tank: Here, the flow of the water is slowed down even further so as to separate matter that can settle. In general, the water is expected to remain in the tank for six hours and the settling rate is expected to be 1.00 m/hour. However, this settling rate is not entirely sufficient. Together with the water, slowly settling solid matter also finds its way into the biological stage.

a biological stage: This refers to large clarifying tanks, where the organic matter still present in the waste water in dissolved form (emulsion) is degraded (oxidized) using bacteria and the oxygen in the air. Air can be supplied in a variety of ways. The presently conventional form of air supply is to blow in air through the floor membranes. The air thus bubbles through the entire volume of water and supplies the bacteria with the necessary oxygen. Large compressors are continuously operated day and night for this purpose.

a secondary clarifying tank: In the biological stage, the water is swirled around, thus keeping many dirt particles, which primarily comprise dead bacteria, suspended. These particles settle in the secondary clarifying tank with the appropriate residence time before the water is introduced into the receiving waters.

Formerly, waste water purification ended with the biological stage and secondary clarifying tank. For several years now, we also have a third purification stage available, this being phosphate-nitrate removal. Because phosphates predominantly settle and end up in the sludge, the nitrates must be degraded by means of nitrification-denitrification.

The more thorough the waste water purification process is, the greater the residue that remains in the form of sludge. Organic sludge, and in particular municipal sewage sludge, is a malodorous mass full of bacteria and viruses, which is suctioned off the clarifying tanks in the form of a thin slurry containing 0.5 to 1.5% dry substance (TS), combined, thickened to approximately 7% TS, and putrefied in digestion towers. This involves anaerobic (without oxygen) digestion, which lasts 20 to 30 days, depending on the method. The sludge must be constantly heated to a temperature of 37° C. Methane gas forms in the process, which is incinerated in co-generation plants, so as to generate power. The heat of the waste gases is recirculated into the digestion tower so as to heat the same to the required temperature of 37° C. The heat that is generated generally suffices, but often, during the winter months, the temperature requires boosting by way of primary energy combustion (natural gas, heating oil).

The residual sludge remains in the digestion towers at 3.5 to 4.0% TS, and this must be disposed of. Given the enormous quantities, this sludge must be reduced using mechanical dewatering measures. The centrifuge achieves approximately 22 to 26% TS, the belt press approximately 24 to 30% TS, the chamber filter press approximately 28 to 35% TS, and the chamber membrane press up to 38% TS.

Thereafter, the dewatered sludge must be disposed of. Disposal as fertilizer in agriculture, which was previously common, is decreasing for a variety of reasons. Because organic sludge can no longer be used for land fill, the only way to manage the waste is by incineration. Along with this, the 62 to 78% of water must also be disposed. Because water, as is known, does not burn, and the sludge having a high water content cannot be incinerated by itself, large amounts of primary energy sources (natural gas, heating oil) are required to dispose of this unpleasant waste product on a daily basis.

The conventional sewage treatment plant also requires large surface areas, which for a sewage treatment plant for a population equivalent of 100,000 can amount to 15,000 to 20,000 m², depending on the situation.

This complicated technology has high investment costs and operating costs. These costs are apportioned among the households by sewage authorities and paid together with the waste water charges.

This technology is well entrenched. Revolutionary changes to it are no longer possible.

### DESCRIPTION OF THE TECHNOLOGY OF THE ALTERNATIVE SEWAGE TREATMENT PLANT

The new technology goes back to the roots of the problem stated. This problem is to economically purify waste water, so that the water can be returned to the public water systems without harm, and the method should be simple and affordable. The separated solids should not be regarded as waste, but as energy sources or as recyclable materials, and they should be treated and used accordingly.

The decisive factor for the new development was the realization that the majority of the CSB and BSB5 pollutants can be found in the solids. If these can be separated immediately upon entry of the waste water in the sewage treatment plant, the remaining pollutants can be degraded much more easily and quickly and at a lower cost.

To this end, it was also necessary to accelerate the settling rate of the matter that can settle. For this purpose, the AQUEX RAPID quick sedimentation tank was developed, whereby large amounts of waste water can be mechanically clarified, quickly and thoroughly.

The existing conditioning of slurry also required critical examination. The aim is to recycle the sludge; this cannot, however, be used in the state in which it leaves the dewatering stage of the sewage treatment plants. This requires dewatering at a high percentage level and subsequent drying. Of course, the costs for the drying process must not exceed the value of the end product. This means that drying using primary energy forms is not possible in light of continuously rising energy costs.

The digestion towers deserved special consideration. The sludge that is withdrawn from the various clarifying tanks at 0.5 to 1.5% TS is raw sludge. This raw sludge comprises approximately 75% organic material. Approximately 35% of this is metabolized in the digestion tower, which is to say converted into methane gas. This corresponds to 46.7% of the total energy content.

The gas is incinerated in co-generation plants, thus generating power. At a 90% incinerator efficiency, 42% of the energy remains, from which approximately 35% power, which is to say 14.7% of the total energy content is generated.

The exhaust heat is used to heat the digestion tower, which is to say for internal purposes. The digestion tower, which is associated with very high construction costs, thus provides an energy output of only 14.7% of the total energy content. This is extraordinarily low, considering that the residual sludge from the digestion tower still has to be dewatered and disposed of (destroyed) at an energy content that is still high.

With drying and incineration of the sludge, the total energy content can be thermally recycled and 29.17% power, which is approximately double the amount, can be generated. The residual heat is used to dry the sludge to 95 to 98% TS. The waste heat that develops during the subsequent waste air conditioning is still high and can be used to generate hot water, together with the many recycling options that are associated therewith. Only the ashes have to be disposed of, but these ashes can also be utilized in a variety of ways.

All these are compelling arguments to dispense with the expensive digestion tower, which dissipates energy.

The technical changes are intended to radically lower the investment costs and operating costs.

These are the objectives of the alternative sewage treatment plant.

The technology of the alternative sewage treatment plant comprises two parts:

waste water conditioning and sludge treatment, with the objective of obtaining a recyclable material as the end product for the subsequent thermal or material recycling process.

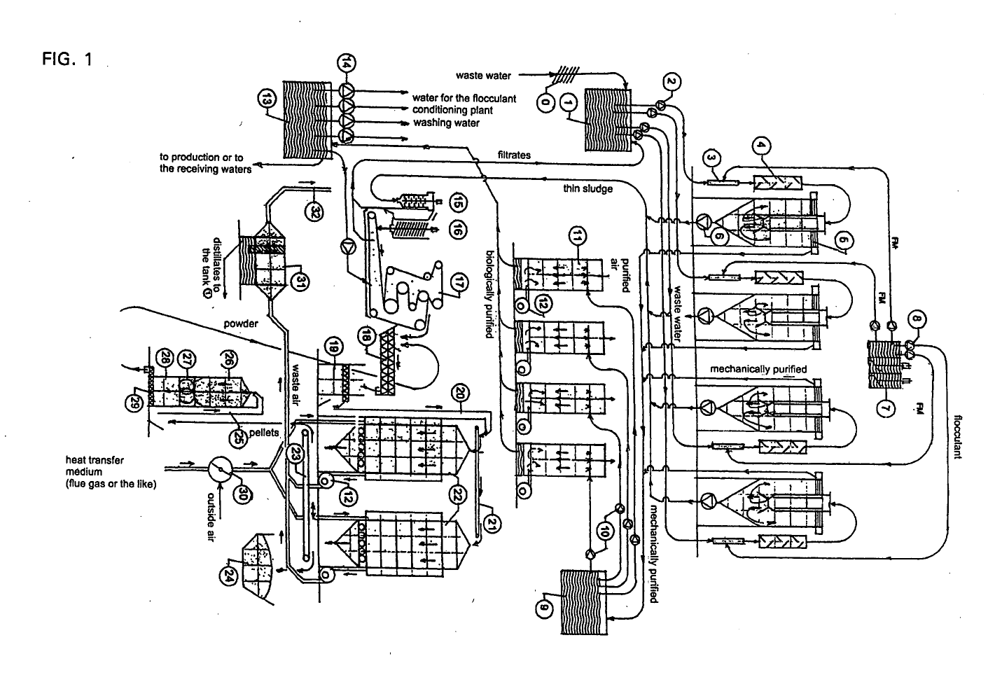

Waste Water Conditioning (FIG. 1)

The waste water passes through the coarse screen and strainer (0) where the coarsest solids are separated. These are treated as in conventional sewage treatment plants.

The waste water is suctioned from an intermediate reservoir (1) using a suction pump (2) and pumped into the AQUEX RAPID quick sedimentation tank (5). However, prior to that, organic flocculant is added to the waste water stream from a flocculant conditioning plant (7) using a flocculant metering pump (8). The addition is preferably carried out via an injection pipe (3) so as to uniformly distribute the flocculant in the waste water. Optionally, it is also possible to add flocculant in the suction pump. The waste water is provided with the intermediate residence time required for flocculation in a static mixer (4).

The solids are separated from the liquid in the quick sedimentation tank. The quick sedimentation tank is a device that is described in patent application DE 44 26 052 A1. The disclosure of this German patent application is hereby expressly referenced and incorporated in the present application. The essential idea of this quick sedimentation tank is that two defined, opposing flows are artificially produced in a circular tank having a conical outlet: a fast downward flow and a slow upward flow. The flocculated waste water, which is conducted into the tank at high speed, is decelerated in the tank and rotated slowly upward because the water can drain only at the top, into an annular channel. However, the solids, having a higher specific weight than the water, maintain the downward movement thereof for a longer period than the water, due to inertia of the solids, and collect in the cone of the tank as sludge. From here, the sludge is suctioned off periodically using a hose pump (6).

A sand trap, a sand washing system and a mechanical sedimentation tank are deliberately omitted. The sand remains in the sludge. This has several advantages. The cost of the sand trap and sand washing system is saved, and the sand causes drainage in the sludge, resulting in improved dewatering results. The sand can be found in the ashes following the incineration of the sludge, making them recyclable in a variety of ways.

The mechanically purified waste water is suctioned in from an intermediate reservoir (9) by means of metering pumps (10) and is pumped into a bioreactor (11). The bioreactor is an upright cylinder, which is filled with synthetic carrier material for bacteria. The introduction of the waste water and the distribution should advantageously be done so that a layer of filler material measuring 30 to 40 cm in thickness remains above the point of introduction. The air exiting the bioreactor is thus also purified and no gases can escape. Bacteria are injected into the filler material. Optionally, it is possible to admix enzymes to the waste water so as to expedite the multiplication of the bacteria. Excess air is blown through from beneath as a counter flow, using a fan (12), so as to supply the bacteria with sufficient oxygen. The blowing is done such that an air cushion is formed at the bottom, in which the pressure is uniform. The entire reservoir cross-section is thus supplied uniformly with air.

The remaining CSB and BSB5 pollutants are degraded in the bioreactor so that the water can be conducted into the receiving waters. It shall be expressly pointed out that this is only possible because the CSB and BSB5 pollutants have been significantly lowered by separating the solids in the quick sedimentation tank. Large-scale tests have shown that the CSB and BSB5 pollutants can be reduced between 55 and 58% in municipal waste water, and as much as 95% in liquid pig manure, by separating the solids.

Optionally, it is of course also possible to biologically purify the mechanically purified water in the conventional manner using a biological tank.

The nitrates are also partially degraded in the bioreactor. Depending on the waste water, this degradation may suffice to meet the approved limits. Should this not be the case, a small denitrification system can optionally be connected downstream of the bioreactors. The phosphates do not cause any problems and remain in the sludge.

Sludge Conditioning

The sludge, which also contains the sand, collects in the cone of the quick sedimentation tank. It is already flocculated and can thus be directly dewatered, without further treatment. It is necessary that the slurry be gently moved into the dewatering units without destroying the flocculation structure that has formed. For this reason, a hose pump is used for this purpose.

The sludge is suctioned off periodically. The work of the hose pump is regulated by a sludge level probe. This process also ensures that the sludge does not become too thick in the cone of the tank, which can negatively influence suctioning. Large-scale tests have shown that the degree of thickening in the cone can reach 25 to 30% TS, depending on the type of waste water.

The sludge that is suctioned off is raw sludge and, in this state, still contains all the organic components, and thus the full energy content. This energy content should be retained fully until this is thermally recycled or used as fertilizer.

When conditioning sludge in the alternative sewage treatment plant, the biological stage and digestion tower, which dissipate energy, are entirely dispensed with.

The sand remains in the sludge and can be found in the ashes following the incineration. The sand causes drainage in the sludge and thus advantageously impacts the dewatering process.

The sludge that has been suctioned from the quick sedimentation tank is pumped into a pre-dewatering cylinder where it is pre-dewatered by gravity. The TS that can be achieved is approximately 25 to 28% for raw municipal sludge.

From the pre-dewatering cylinder, the pre-dewatered sludge slides into the pre-thickening cylinder, where it is further dewatered, also by gravity. The degree of dewatering can amount to 30 to 35% for raw municipal sludge.

The pre-dewatered sludge drops onto a belt press and is pressed further to 40 to 44% TS. Given the thorough pre-dewatering, a smaller press is also sufficient. The sludge can be pressed at a higher pressure than customary, which is one of the reasons why the press achieves an unusually high degree of dryness.

In addition, the sludge should be dried. In order to be able to conduct drying economically, the sludge must be pelletized. In the alternative sewage treatment plant, this is done by extrusion. For this purpose, an extruder is used, in which the perforated plate is automatically and continuously cleaned, so as to prevent clogging of the dies.

Drying is carried out in a trickle drying shaft. The wet pellets are added at the top, and the dry pellets are removed at the bottom, using appropriate opening elements. The material trickles through the dryer due to gravity and is subjected to hot air from horizontal drying channels.

The dry pellets typically drop, at approximately 95 to 98% TS, onto a conveyor belt and are loaded into containers or intermediate reservoirs for recycling (for example incineration and power generation). The degree of dryness, however, can be adjusted randomly if desired by regulating the emptying step.

The drying air normally comprises flue gases from industry or from the thermal recycling of the sludge. Drying is carried out at low temperatures so as to prevent increased vapor formation. Flue gases having higher temperatures are cooled to the desired temperature in a bypass controlled by a thermostat by supplying outside air. The pelletization and the trickle shaft dryer prevents undesirable dust formation, which can result in dust explosions, with organic sludge. Optionally, arbitrary heat sources can be utilized by means of heat exchangers.

By diluting the flue gases, the temperature of the outside air is also used for drying, whereby drying energy is saved.

A fan draws the drying air through the dryer and pumps it to the waste air conditioning station. This creates a negative pressure in the dryer which prevents gases from escaping from the dryer.

The waste air conditioning process comprises a waste air scrubbing step using a biofilter, where the air is purified mechanically and biologically before it leaves the system via a chimney.

During the waste air conditioning process, waste heat is generated which can be used to produce hot water. Hot water can be used in a wide variety of ways (for example, for heating buildings, greenhouses, stables, and the like).

The entire energy of the sludge is thus used 100% three times in a row: for generating power, for drying, and for internal operational purposes.

Economic Efficiency

An alternative sewage treatment plant can be constructed at approximately 30 to 50% of the existing investment costs at the same efficiency. The operating costs are reduced to the same degree. The size of the land parcel required by the alternative sewage treatment plant is only approximately 5 to 10% of the usual surface area.

Given the economic efficiency of the alternative sewage treatment plant, it in particularly suitable for construction in developing and emerging countries. However, existing sewage treatment plants can also be operated with some of the new technology. For example, the burden on overloaded sewage treatment plants can be relieved by providing one or more quick sedimentation tanks, without having to build a new plant.

The conditioning of the sludge using pelletization, drying, incineration and power generation can also be employed effectively in existing sewage treatment plants.

By using the quick sedimentation tank and bioreactor, the problem of conditioning waste water in thinly populated areas can be solved economically, because the construction of expensive collectors can be avoided.

1. A method for conditioning municipal, industrial and agricultural waste water, comprising: organic flocculant is admixed with the waste water, solids are separated in a quick sedimentation tank by gravity, mechanically purified water is chemically-biologically purified in a bioreactor, the sludge collected in the quick sedimentation tank is conducted into a pre-dewatering cylinder and a pre-thickening cylinder and dewatered there by means of gravity, pre-thickened sludge is re-pressed by means of a sludge press, the press cake is shaped into pellets, the pellets are conveyed into a dryer through which the wet pellets trickle as a result of gravity, wherein during this process the pellets are permeated by warm drying air, containing flue gases from industry or incineration, and dried to a high degree of dryness, and are either loaded into containers to be transported away or into an intermediate reservoir for further recycling, or the pellets are pulverized so as to improve the dry substance of the sludge in a mixer for pelletization, hot flue gases are cooled to the desired drying temperature by admixing with outside air, drying air is drawn through a dryer using a fan and pumped into a waste air conditioning system, where dust is flushed out of the air, and the waste air is subjected to final purification in a biofilter before it escapes via a chimney.

2. The method according to claim 1, wherein the flocculant is admixed to a waste water stream via an injection pipe and a static mixer.

3. The method according to claim 1, wherein the flocculated waste water is conducted into one or more quick sedimentation tanks and collected sludge is suctioned from a cone using a hose pump, the operation of which is controlled by a sludge level probe.

4. A method according to claim 1, wherein the waste water is introduced in the bioreactor filled with carrier material in which bacteria have been injected, and in which air is blown through in a counter flow direction, including an option of backwashing.

5. A method according to claim 1, wherein a nitrate/phosphate elimination system is installed in the outflowing water pipe.

6. A method according to claim 1, wherein the sludge that has been thickened in the quick sedimentation tank is pre-dewatered by gravitation in the pre-dewatering and the pre-thickening cylinders and is then re-pressed on the sludge press.

7. The method according to claim 1, wherein the pressed-out sludge cake drops into the mixer, where dry powder from the internal material that has been conditioning in a pulverization system is admixed to the sludge so as to increase the dry substance.

8. The method according to claim 1, wherein the mixture drops from the mixture into a pelletizer that is provided with a cleaning system for the perforated plate, where the mixture is shaped into pellets having various diameters and lengths by means of extrusion.

9. The method according to claim 8, wherein the wet pellets are lifted into dryers using suitable conveying means, where the pellets trickle through the dryers and are subjected to hot air from flue gases or another type of waste heat at a low temperature so as to dry the pellets, wherein in several dryers the pellets are added by means of a distribution belt having diverters and emptied by means of cellular wheel sluices or slides onto a belt that can move in both directions.

10. A method according to claim 1, wherein the drying temperature of the flue gases is controlled in an air admixing unit, where a motor controlled by a thermostat admixes as much outside air as is needed to reach the desired temperature via adjustable louvers or air valves.

11. A method according to claim 1, wherein a the fan, which draws the drying air through the dryer, also pumps the air into a waste air conditioning system, where dust is flushed out of the air using water and the air is condensed out and subsequently biologically purified in the bioreactor, wherein the waste heat that is released is utilized via heat exchangers for water heating and the like.

12. A plant for carrying out the method according to claim 2, wherein an injection pipe is provided for the metered addition of flocculant, the injection pipe being installed in the waste water pipe by means of flanges and comprising a flocculant distribution container having four pipe nipples as outlets, which are connected to hoses having four pipe nipples on the injection pipe, which are distributed over the circumference and length of the pipe.

13. A plant for carrying out the method according to claim 3, wherein the flocculated waste water is conducted in a round tank having a conical outlet, an annular channel and an annular filter, where a mandrel installed in the container creates two defined, opposing flows: a fast downward flow and a slow upward flow wherein the water, which is introduced at high speed, is decelerated in the container and rotated upward because the water can drain only at the top into an annular channel, the solids, having a higher specific weight than the water, maintain the downward movement thereof for a longer period than the water due to the inertia of the solids and collect in a cone of the tank in the form of and the sludge is suctioned from the tank by a hose pump in response to a signal from a sludge level probe.

14. A plant for carrying out the method according to claim 4 in a bioreactor comprising an upright cylinder, which is filled with a synthetic carrier material, the waste water is introduced at the top and distributed over the filler material by means of a reaction wheel or other distribution mechanism, the lower part of the tank is designed as a basin, which is filled with water that drains off, the water level is controlled by a spillway, connections are also provided for sludge removal and for water for the backwashing of the carrier material, the latter is also used as a water drain, valves are provided at the spillway and air feed to prevent undesirable water drainage during backwashing, an air cushion is formed over the water by keeping the carrier material at a distance from the water surface using a stainless steel construction, a fan blows air in the air cushion, and the air then uniformly permeates the carrier material, for repair purposes, the tank is equipped with a manhole, during operation, the tank is closed by a woven filter fabric, the space over the reaction wheel is also filled with carrier material, to which bacteria have been injected, and the waste air from the bioreactor is thus purified.

15. A plant for carrying out the method according to claim 6 for gravitational pre-dewatering of the sludge, comprising two stainless steel cylinders which comprise two cylinders that are nested inside each other, the inner cylinder comprises a filter medium, the outer cylinder is used to collect the filtrates, a slow worm runs in the inner cylinder, the sludge is introduced into the first cylinder from beneath and runs through the cylinder from the bottom to the top, and through the second cylinder from the top to the bottom, and is dewatered in between by gravity, the filter cylinders are cleaned by means of a washing system, and the pre-dewatered sludge leaves the second cylinder via a drain mechanism.

16. A plant for carrying out the method according to claim 7, comprising a powder conditioning system to enable the powder to be mixed with the press cakes, comprising an intermediate reservoir for dry pellets, combined with a mill, preferably a hammer mill having a powder container, from where the powder is metered into the mixer using suitable means, and the material is transported inside the plant by the effect of gravity.

17. A plant for carrying out the method according to claim 8, comprising a pelletizer as the extruder made of steel, comprising a hopper, a full and empty detection sensor, a loosening shaft, feed worm, working worm, blade and perforated plate, the blade rotates in front of the perforated plate and always keeps it clean, and the working worm, blade and perforated plate can be reinforced.

18. A plant for carrying out the method according to claim 9, comprising a diverting device on the filling belt, the belt has lateral upturns, the upturn is interrupted at the filling opening of the dryer and designed as a rotatable panel, which is fastened to the remaining upturn by hinges, in response to a signal from the empty detection sensor of the dryer, the panel opens 45° and blocks the path of the pellets in the straight direction. The pellets are diverted laterally into the dryer via a chute, in response to a signal from the full detection sensor, the panel closes again, releasing the path for filling the next dryer, the panel is opened and closed by a pneumatic piston or electrically.

19. A plant for carrying out the method according to claim 9, comprising a dryer made of galvanized steel, aluminum or stainless steel construction having three pits, the center, large pit is the actual dryer, the two lateral pits are used to introduce and distribute the drying air or collect the waste air, the drying air is advantageously introduced at approximately half the height of the dryer; the waste air is discharged at the bottom on the intake side by means of a fan, the dryer comprises modular units that are stacked on top of one another, in this way, the capacity can also be controlled within a particular scope, the modular units contain at least two, and sometimes four, rows of ventilation channels, which are shifted by a half an axis on top of each other, they connect the two lateral pits through the dryer shaft and are distributed over the entire dryer pit, the air channels have a small roof-like shape, which opens at the bottom, at the end faces, the channels have openings on one side and are closed on the other side, the channel rows located on top of one another have opposite polarities, the air taken in through one channel row cannot exit on the other side, and is forced to exit at the bottom and continue in the channel row above or below, which has reverse polarity, the drying air is thus forced to uniformly permeate the entire volume of pellets, the dryer is always filled with pellets, which are replenished at the top and withdrawn at the bottom at short intervals via cellular wheel sluices or slides, the entire volume of pellets thus trickles through the dryer due to gravity and is dried, the discharge device can be controlled, and in this way, the residence time in the dryer, and thus the desired degree of dryness, can be controlled, the dryer is seated on a base and comprises filling and emptying funnels, full and empty detection sensors, a thermometer, and control openings for cleaning the dryer, and the inlet side of the air channels can be closed by slides, so that the dryer can be heated in sections during filling.

20. A plant for carrying out the method according to claim 10, comprising an air admixing unit for regulating the drying air, the flue gases generally arrive at a higher temperature than the desired drying temperature. In order to cool them to the desired temperature, outside air is admixed to the flue gases, and this is done in a pipe-hose piece in smaller plants, one side is installed in an air line, and the projecting part is provided with an air valve, which is opened or closed by a motor controlled by a thermostat, the thermostat is installed in the outflowing air stream. In larger plants, a box is installed in the cross-section of the air line, and louvers that can be adjusted by a motor are located on both sides and operate according to the same principle as the air valve.

21. A plant for carrying out the method according to claim 11, comprising a vertical or horizontal component that has a square cross-section and is made of reinforced concrete, the lower part is designed as a basin for receiving the condensates, the waste air is introduced above the water level, the chimney is located on the roof of the component, at a certain height, nozzle fittings are provided, which have special spray heads that spray downward, underneath a close-meshed stainless steel net is provided to better disperse the water, a number of inclined water wiper blades made of synthetic material are located above the nozzle fittings, underneath a synthetic honeycomb design is provided, to which microorganisms have been injected, as the biofilter for air purification, the air, which is introduced horizontally, is rotated upward and saturated with water in the counter flow direction to flush out the dust, the dust collects in the basin as sludge, is periodically suctioned off and disposed of, the flushing process cools the air and condenses it out, the condensate collects in the basin and runs into an underground water tank via a spillway, and from there, a pump—preferably a centrifugal pump—suctions in the amount of water that is required for washing the filter surfaces, the excess runs into the receiving waters via a spillway or back to the sewage treatment plant inlet, the waste air scrubber contains a plurality of inlet stages having a landing for the control door and interior and exterior lighting, the water in the underground container still contains a relatively large amount of heat, and this heat is rendered usable by means of a heat pump or heat exchanger.
